(19) United States
(12) Patent Application Publication
(10) Pub. No.: US 2015/0306769 A1
(43) Pub. Date: Oct. 29, 2015

(54) CALIBRATION FOR ROBOTIC SYSTEMS

(71) Applicant: Matthew E. Trompeter, Macomb, MI (US)

(72) Inventor: Matthew E. Trompeter, Macomb, MI (US)

(21) Appl. No.: 14/710,933

(22) Filed: May 13, 2015

Related U.S. Application Data
(63) Continuation-in-part of application No. 14/155,646, filed on Jan. 15, 2014, now abandoned.
Application No. 14/155,646 is a continuation-in-part of application No. PCT/US2013/000146, filed on Jun. 10, 2013.
Application No. PCT/US2013/000146 is a continuation-in-part of application No. 13/385,797, filed on Mar. 7, 2012, now Pat. No. 9,061,421.
Application No. 13/385,797 is a continuation-in-part of application No. 13/385,091, filed on Feb. 1, 2012.
(60) Provisional application No. 61/518,912, filed on May 13, 2011.
(60) Provisional application No. 61/465,080, filed on Mar. 14, 2011.

(51) Int. Cl. B25J 9/16; G06F 17/50

(52) U.S. Cl. CPC B25J 9/1671; G06F 17/50; Y10S 901/02; Y10S 901/41

(57) ABSTRACT

The robot calibration systems combine a work object with an industrial robot and a robot tool. Three different work objects can be used with the system. This technology enables the user to visually see a robotic reference frame, a frame in space that is relative to the industrial robot and workpiece that is otherwise abstract. Enabling the user to visually see the robotic reference frame on the manufacturing shop floor enables adjustment of the robotic frame to the shop floor and correction of a robotic path or off-line program to enhance accuracy. Two laser beams are emitted and intersect at a laser intersection point. The laser intersection point and the laser beams are then used to define a robotic reference frame. The technology improves cost and time factors in applications where absolutely accurate robots are not necessary.

### CROSS-REFERENCE TO RELATED APPLICATIONS

This application is related to and claims priority to U.S. Provisional Application No. 61/465,080, entitled “ROBOTIC WORK OBJECT CELL CALIBRATION SYSTEM AND METHOD,” (Trompeter), filed on Mar. 14, 2011, to U.S. Provisional Application No. 61/518,912, entitled “ROBOTIC WORK OBJECT CELL CALIBRATION SYSTEM AND METHOD,” (Trompeter), filed on May 13, 2011, to U.S. Ser. No. 13/385,091, entitled “ROBOTIC WORK OBJECT CELL CALIBRATION SYSTEM,” (Trompeter), filed on Feb. 1, 2012, to U.S. Ser. No. 13/385,797, entitled “ROBOTIC WORK OBJECT CELL CALIBRATION METHOD,” (Trompeter), filed on Mar. 7, 2012, to PCT Application No. PCT/US2013/00146, entitled “AUTOMATIC AND MANUAL ROBOT WORK FINDER CALIBRATION SYSTEMS AND METHODS”, (Trompeter) filed on Jun. 10, 2013, and is a continuation-in-part to U.S. Ser. No. 14/155,646, entitled “ROBOT CALIBRATION SYSTEMS”, (Trompeter), filed on Jan. 15, 2014.

### FIELD OF USE

The present invention relates to a calibration system for use with an industrial robot.

### BACKGROUND OF THE INVENTION

The value of industrial robots has historically been driven by the automotive industry. However, that value is now being realized in other industries, as robots are being designed for tasks as diverse as cleaning sewers, detecting bombs, and performing intricate surgery. The number of industrial robots sold globally in 2013 was nearly 180,000 units, essentially tripling the number of units sold in 2009, with the automotive, metal, and electronics industries driving the growth.

Prior approaches to calibrating industrial robots use measuring devices either determine the inaccuracies of the robots after the robot is built, or measure work piece positions relative to the robots' positions prior to off-line programming.

Some of the prior art includes:

U.S. Pat. No. 8,651,858 (Berckmans, et al.) discloses a method of creating a 3-D anatomic digital model for determining a desired location for placing at least one dental implant in a patient's mouth. One such method uses a calibration device that involves two intersecting lasers to place a dental implant into a cast model of a patient's mouth. The lasers are not mounted onto a fixture since the fixture-to-robot location is known. The method creates a 3-D anatomic digital model for determining a desired location for placing at least one dental implant in the mouth of a patient.

U.S. Pat. No. 7,979,159 (Fixell) discloses a method and a system for determining the relation between a local coordinate system located in the working range of an industrial robot and a robot coordinate system. The method includes attaching a first calibration object in a fixed relation to the robot and determining the position of the first calibration object in relation to the robot. Then, locating at least three second calibration objects in the working range of the robot, a reference position for each of the second calibration objects in the local coordinate system can be determined by moving the robot until the first calibration object is in mechanical contact with each second calibration object. By reading the position of the robot when the calibration objects are in mechanical contact the relation between the local coordinate system and the robot coordinate system can be calculated.

U.S. Pat. No. 7,945,349 (Svensson, et al.) discloses an invention which relates to a method and a system for facilitating calibration of a robot cell. One or more objects and an industrial robot perform work in connection to the objects, wherein the robot cell is programmed by means of an off-line programming tool including a graphical component for generating 2D or 3D graphics based on graphical models of the objects. The system comprises a computer unit located at the off-line programming site and configured to store a sequence of calibration points for each of the objects, and to generate a sequence of images including graphical representations of the objects to be calibrated and the calibration points in relation to the objects, and to transfer the images to the robot, and that the robot is configured to display the sequence of images to a robot operator during calibration of the robot cell so that for each calibration point a view including the present calibration point and the object to be calibrated are displayed for the robot operator.

U.S. Pat. No. 7,756,608 (Brogardh) discloses a method for calibrating an industrial robot including a plurality of movable links and a plurality of actuators effecting movement of the links and thereby the robot. The method includes mounting a measuring tip on or in the vicinity of the robot, moving the robot such that the measuring tip is in contact with a plurality of measuring points on the surface of at least one geometrical structure on or in the vicinity of the robot, reading and storing the positions of the actuators for each measuring point, and estimating a plurality of kinematic parameters for the robot based on a geometrical model of the geometrical structure, a kinematic model of the robot, and the stored positions of the actuators for the measuring points.

“Calibration of Robot Reference Frames for Enhanced Robot Positioning Accuracy, Robot Manipulators”, Frank Shaopeng Cheng (2008) (pages 95-112) discusses robot calibration using tool center points. The Cheng reference relates to industrial robot manipulators which are important components of most automated manufacturing systems. The reference does not mention lasers. While a “tool center point” is generally defined as the origin of the tool coordinate system, a “laser intersection point” is a point where two or more lasers intersect.

What is needed is a robot calibration system for use with industrial robots to improve cost and time factors in applications where absolutely accurate robots are not really necessary. Examples include body-in-white applications, resistance welding, material handling, and MIG welding.

The primary objective of the robot calibration system of the present invention is to provide a calibration system that is simpler to operate, results in improved precision, involves a lower investment cost, and entails lower operating costs in a manufacturing environment.

### SUMMARY OF THE INVENTION

The robot calibration system of the present invention address these needs and objectives.

The calibration system comprises means for emitting a pair of lasers beams. The first preferred embodiment of the calibration system of the present invention requires that the lasers are mounted so that the laser beams intersect at a 90 degree angle. The second preferred embodiment of the calibration system of the present invention requires that the lasers are mounted so that the laser beams intersect at a range of angles from between 85 degrees and 95 degree relative to each other, at a laser intersection point. The laser intersection point defines the location of a robotic reference frame.

The geometry of the work object is preferably basic and the lasers are mounted in an L-shaped or F-shaped member. The angular positions of a robot tool are adjustable relative to the robotic reference frame.

The first preferred embodiment of the calibration system of the present invention, the work object includes two lasers positioned onto a work piece or tool, at a known location (a numerical control block or NAAMS mounting pattern) with the two laser beams intersecting at a 90 degree angle and continuing to project outward. A laser intersection point of the two laser beams defines the correct location of the robotic reference frame. To accomplish this, the robot records a laser intersection point. A second point is then recorded along the axis of the first laser beam. A third point is then recorded along the axis of the second laser beam. Once all three (3) points are known, the robotic reference frame is generated. Alternatively, in another preferred embodiment of the calibration system of the present invention, the robotic reference frame is defined by the first and second intersecting laser beams. The robotic reference frame is then used to adjust the angular position of the robot tool, which can involve adjusting roll, pitch and/or yaw of said robot tool. The robotic reference frame is the recorded in the real world position/ shop floor position. The robot's path is then adjusted to the correct robotic reference frame. The robot's path was generated in CAD and downloaded in CAD to this reference frame. When tools are assembled and lagged to the shop floor, they don't match the CAD world. This method is applicable for all manufacturing processes including, but not limited to, spot welding, material handling, MIG welding, assembly, cutting, painting and coating, and polishing and finishing.

The adjusting means is a manual robotic tool finder. The adjusting means includes means for retaining the manual robotic tool finder onto a robot tool. The adjusting means enables adjustment of the angular positions of the robot tool relative to the robotic reference frame. The manual robotic tool finder enables generation of the robotic reference frame.

The manual robotic tool finder, in use, enables user alignment of the robot work path by moving the robot into the path of the first or second laser beam until either the first or second laser beam is visible unobstructed through a first or second passageway. The first passageway enables a first laser beam to pass through unobstructed and the second passageway enables a second laser beam to pass through unobstructed. The second passageway intersects the first passageway. The manual robotic tool finder includes a closed position and an open position. The open position enables access to the first and the second passageways.

This technology enables the user to visually see the robotic reference frame, the frame in space that is relative to an industrial robot and work piece tool that is otherwise abstract and cannot be seen. Enabling the user to visually see the robotic reference frame on the manufacturing shop floor will enable the user to adjust the robotic frame to the manufacturing shop floor environment and, thereby, correct a robotic path or off-line program to obtain accuracy.

For a complete understanding of the robot calibration system of the present invention, reference is made to the following detailed description and accompanying drawings in which the presently preferred embodiments of the invention are shown by way of example. As the invention may be embodied in many forms without departing from the spirit or essential characteristics thereof, it is expressly understood that the drawings are for purposes of illustration and description only, and are not intended as a definition of the limits of the invention.

### BRIEF DESCRIPTION OF THE DRAWINGS

FIG. 1 depicts a perspective view of the robot calibration system of the present invention, the system comprising a robot having a robot tool, and a first preferred embodiment of a work object.

FIG. 2 depicts a perspective view of a first preferred embodiment of the work object for use with the robot calibration system of FIG. 1, the work object having two beam-projecting lasers being used for aligning the laser intersection point with the robot tool. “DETAIL A” is a simplified representation of the angular positions (Rₓ, R_{y}, and R_{z}) of the robot tool that are adjustable by the robot calibration system of the present invention.

FIG. 3 depicts a perspective view of the work object of FIG. 2 positioned on a fixture with the robot tool being positioned at the laser intersection point of the work object.

FIG. 4 depicts a perspective view of the work object of FIG. 2 positioned on the fixture with the robot tool being positioned at a second point along the axis of the first laser beam projected from the work object.

FIG. 5 depicts a perspective view of the work object of FIG. 2 positioned on the fixture with the robot tool being positioned at a third point along the axis of the second laser beam projected from the work object.

FIG. 6A depicts a first perspective view of a second preferred embodiment of the work object for use with the robot calibration system of the present invention, the work object having two beam-projecting lasers being used for aligning the laser intersection point of a robot tool. FIG. 2B depicts a second perspective view of the preferred embodiment of the work object of FIG. 2A. FIG. 6C depicts a third perspective view of the preferred embodiment of the work object, similar to the work object shown in FIG. 6A for mounting on a numerical control block or a NAAMS mounting.

FIG. 7 depicts a perspective view of the robot calibration system of the present invention, with the work object of FIGS. 6A and 6B positioned on a fixture, with the robot tool being aligned relative to the laser intersection point of the work object.

FIG. 8 depicts a perspective view of the robot calibration system of the present invention, with the work object of FIGS. 6A and 6B positioned on the fixture as shown in FIG. 7, with the robot tool being positioned at a second point along the axis of the first laser beam projected from the work object.

FIG. 9 depicts a perspective view of the robot calibration system of the present invention, with the work object of FIGS. 6A and 6B positioned on the fixture as shown FIG. 7, with the robot tool being positioned at a third point along the axis of the second laser beam projected from the work object.

FIG. 10 depicts a perspective view of a fourth preferred embodiment of the work object for use with the robot calibration system of the present invention, the work object having two beam-projecting laser beams being used for aligning the laser intersection point with the robot tool.

FIG. 11 depicts a perspective view of the preferred embodiment of a manual robotic tool finder for use with the robot calibration system of the present invention.

FIG. 12 depicts a perspective view of the manual robotic tool finder of the FIG. 11 from above with the upper and lower jaws separated.

FIG. 13 depicts a perspective view of the manual robotic tool finder of the FIG. 11 from below with the upper and lower jaws separated.

FIG. 14 depicts a perspective view of the manual robotic tool finder of FIG. 11, the manual robotic tool finder being mounted onto a weld gun.

FIG. 15 depicts a perspective view of a second preferred embodiment of the robot calibration system of the present invention, the robot calibration system includes the work object of FIGS. 6A and 6B being mounted on a fixture, and the manual robotic tool finder of FIG. 11 being mounted on a weld gun and positioned at the laser intersection point of the work object.

FIG. 16 depicts a second perspective view of the second preferred embodiment of the robot calibration system of FIG. 15, the manual robotic tool finder still being mounted onto the weld gun with the robot tool being positioned at a second point along the axis of the first laser beam projected from the work object.

FIG. 17 depicts a third perspective view of the second preferred embodiment of the robot calibration system of FIG. 15, the manual robotic tool finder still being mounted onto the weld gun with the robot tool being positioned at a third point along the axis of the second laser beam projected from the work object.

### DETAILED DESCRIPTION OF THE PREFERRED EMBODIMENTS

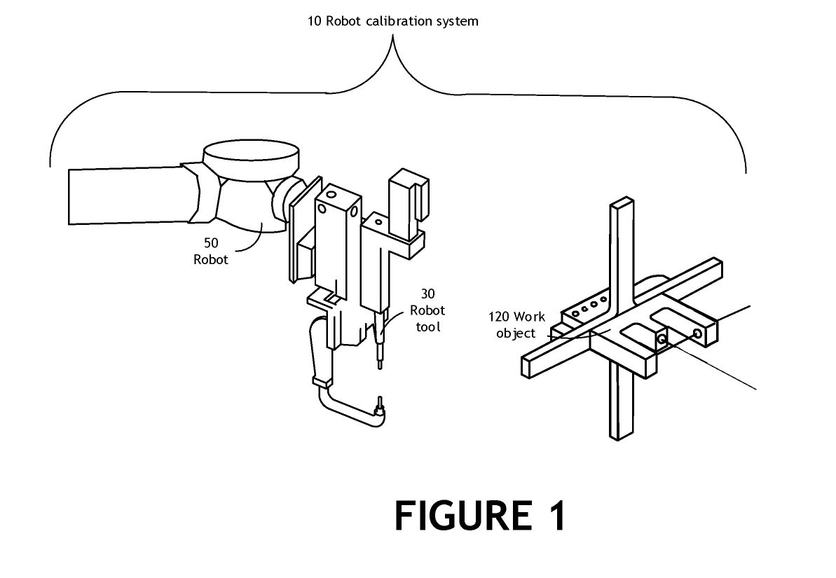

Referring now to the drawings, FIG. 1 depicts the robot calibration system of the present invention. A first preferred embodiment of the work object [120] is combined with a robot [50] and robot tool [30]. The robot tool [30] is a tool used in any number of manufacturing applications including, but not limited to, spot welding, material handling, MIG welding, assembly, cutting, painting and coating, and polishing and finishing.

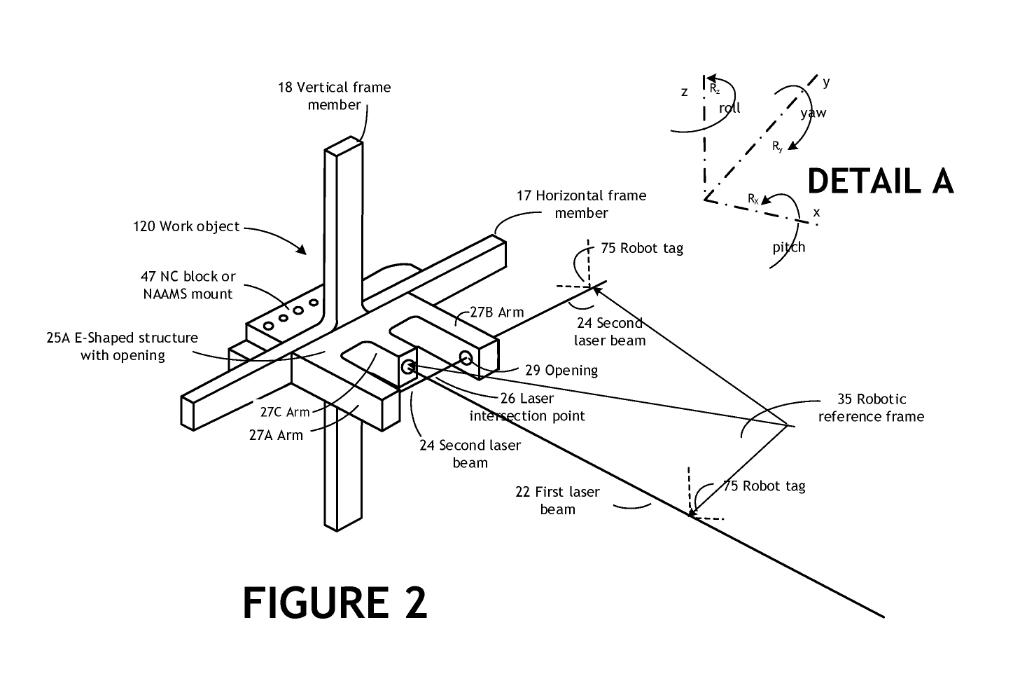

FIG. 2 depicts a second preferred embodiment of the work object [120]. An “E-shaped” structure lies horizontally and is positioned at the center of a frame comprising a horizontal frame member [17] crossing a vertical frame member [18]. Extending along the horizontal frame member [17] are three parallel arms which combine to form the squared “E-shaped” structure [25A] which is horizontally aligned and generally centrally disposed relative to horizontal frame member [17] and vertical frame member [18]. The center arm (27C) of the E-shaped structure [25A] is shorter than the two end arms [27A and 27B].

A first laser beam [22] is emitted from the shortened center arm of the “E-shaped” structure [25A] disposed at the proximate center of the work object [120]. A second laser beam [24] is emitted from one of the arms [27A] of the E-shaped structure [25A] and is directed into and through an opening [29] in the opposing arm [27B]. The laser beams [22 and 24] are preferably red laser modules, having focusable dots (3.5v-4.5v 16 mm 5 mw). A robotic reference frame [35] is defined by the laser intersection point and the first and second laser beams [22 and 24].

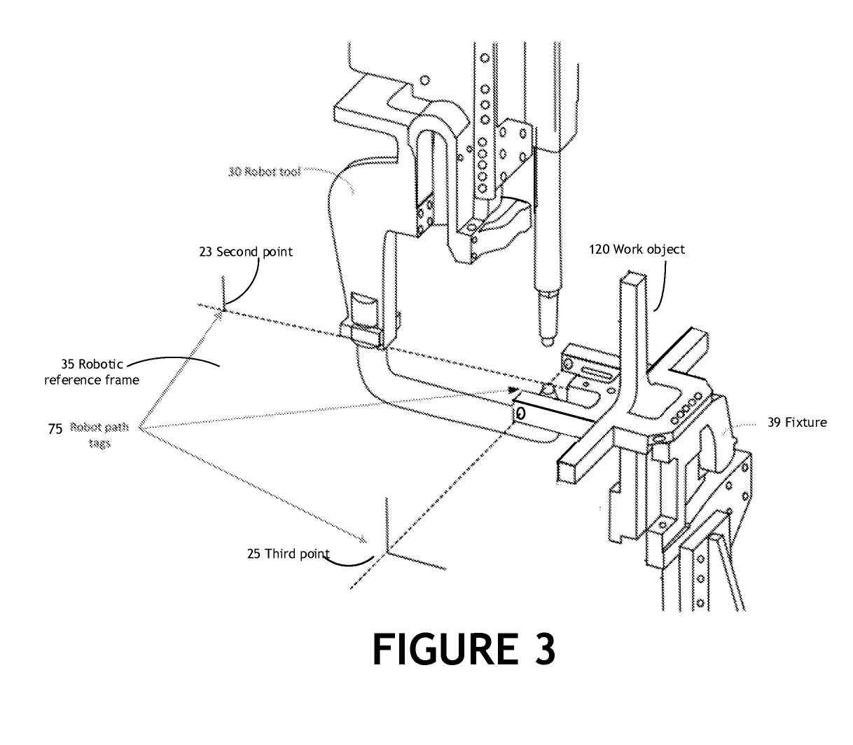

The work object [120] is used to calibrate the work path of a robot tool [30] based upon a point where the two laser beams [22 and 24] intersect, called the laser intersection point [26] of the robot tool [30] (see FIG. 3). The laser intersection point [26] of the robot tool [30] is defined in three dimensions (X, Y, and Z) and relative to their rotational axes Rₓ (pitch), R_{y} (yaw), and R_{z} (roll).

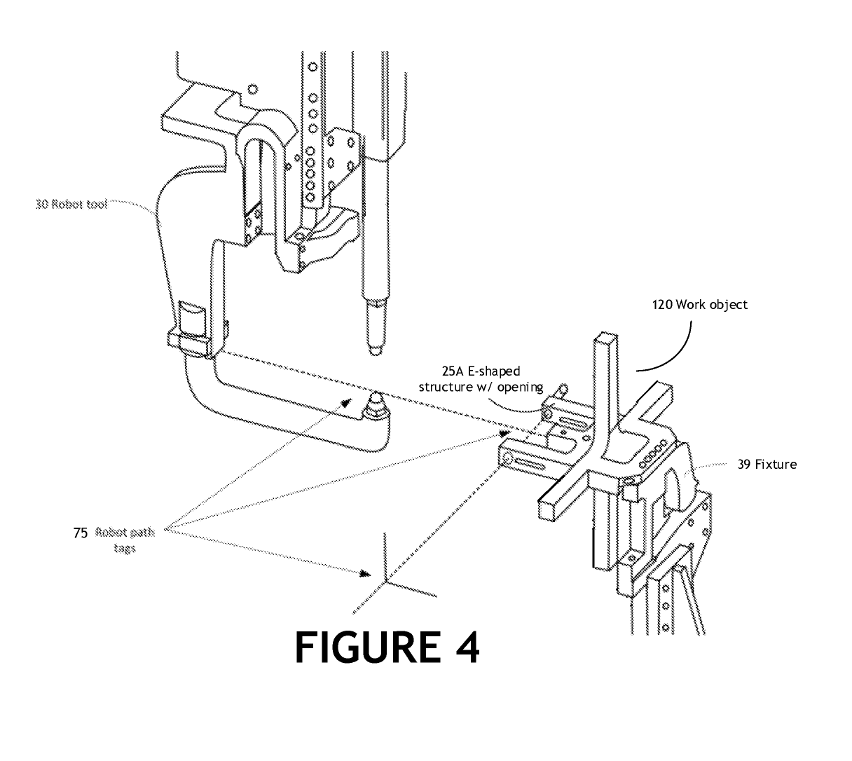

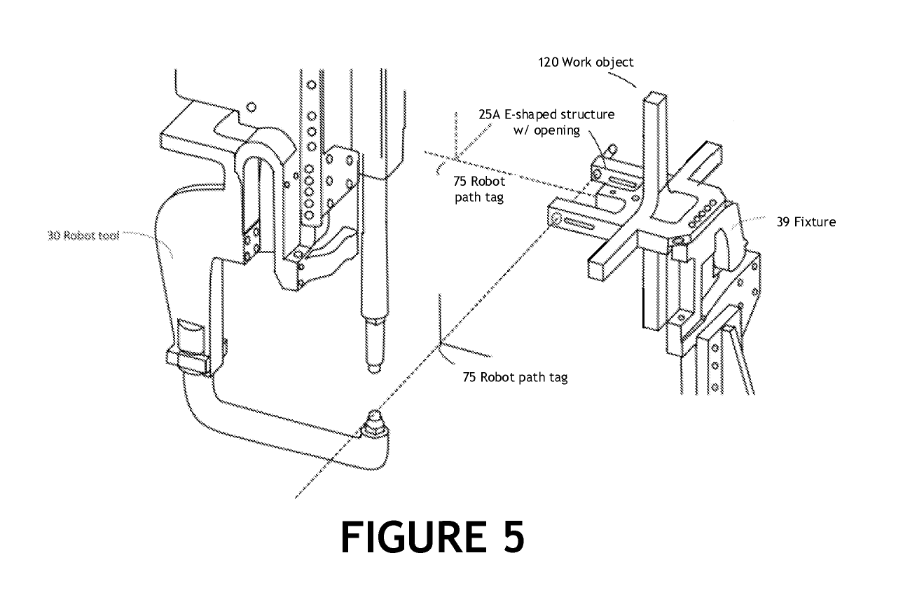

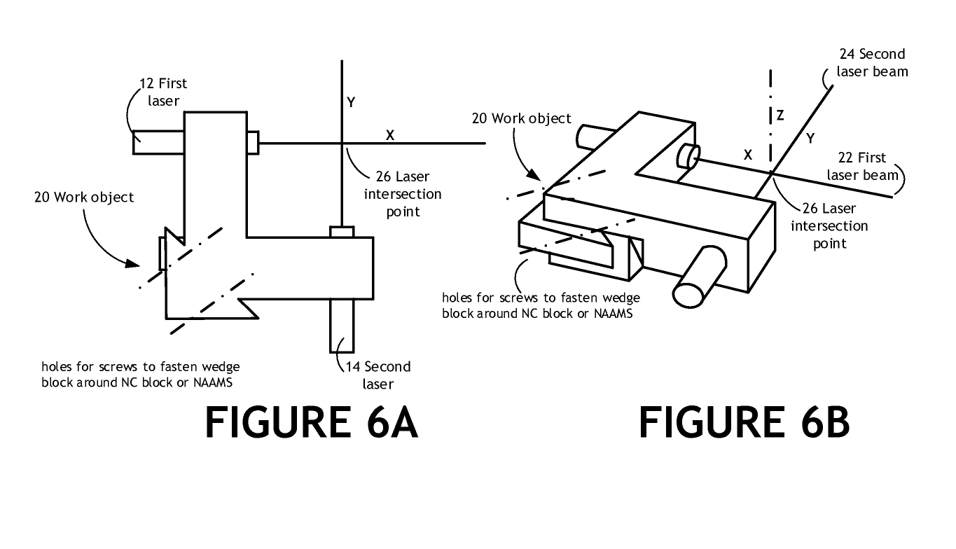

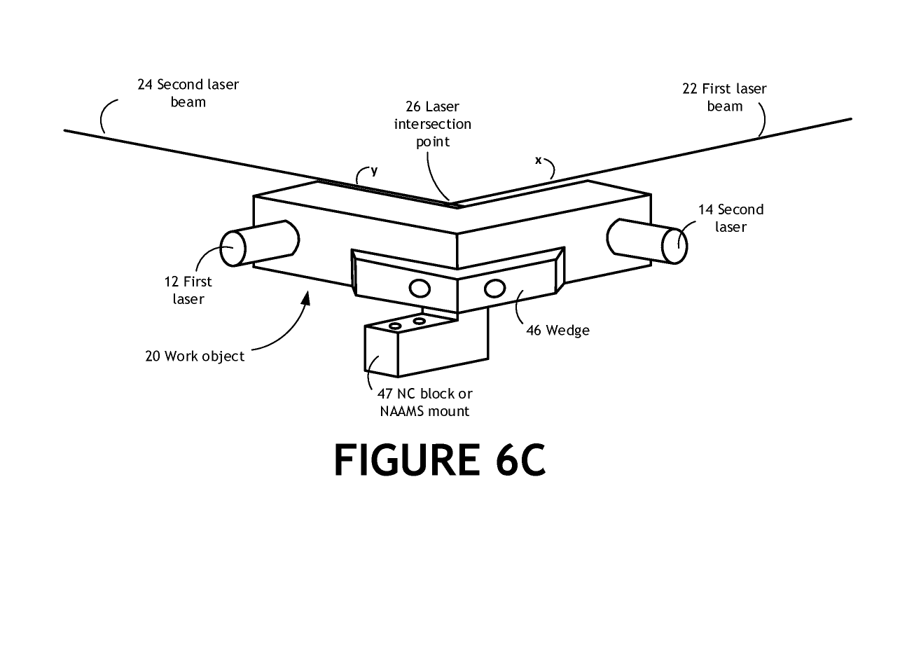

As best shown in FIGS. 6A and 6B, the work object [120] includes two (2) lasers [12 and 14] positioned onto a work piece or robot tool [30], at a known location with the two laser beams [22 and 24] intersecting at a 90 degree angle and continuing to project outward. The mounting is preferably an NC block or a NAAMS mounting pattern [47]. The laser intersection point [26] of the robot tool [30] defines the correct location of the robotic reference frame [35]. To accomplish this, the robot [50] will record a laser intersection point [26]. A second point [23] is then selected along the axis of the first laser beam [22] at a robot path tag [75] (see FIG. 4). A third point [25] is then selected along the axis of the second laser beam [24] at another robot path tag [75] (see FIG. 5).

In other words, the robotic reference frame [35] is defined by the two intersecting laser beams [22 and 24]. Once all three (3) points [23, 25 and 26] are known, the robotic reference frame [35] is generated. The robotic reference frame [35] is then used to adjust the angular position of the robot tool [30], which can involve adjusting either roll and yaw, roll and pitch, yaw and pitch, or roll yaw and pitch of said robot tool [30]. This method is applicable for all robotic processes, including but not limited to, spot welding, material handling, MIG welding, assembly, cutting, painting and coating, and polishing and finishing.

FIGS. 6A and, 6B depict a second preferred embodiment of the work object [20]. The work object [20] preferably has two lasers [12 and 14] securely mounted therein, each laser emitting a laser beam [22 and 24, respectively] therefrom. The lasers are preferably mounted in work object [20] such that the laser beams [22 and 24] intersect each other at a 90° angle. The two laser beams [22 and 24] define a laser intersection point [26]. The mounting is preferably a numerical control (NC) block or a NAAMS mounting pattern [47], attached to the work object [20] with a wedge [46]. FIG. 6C depicts a third perspective view of the preferred embodiment of the work object, similar to the work object shown in FIG. 6A for mounting on a numerical control block or a NAAMS mounting.

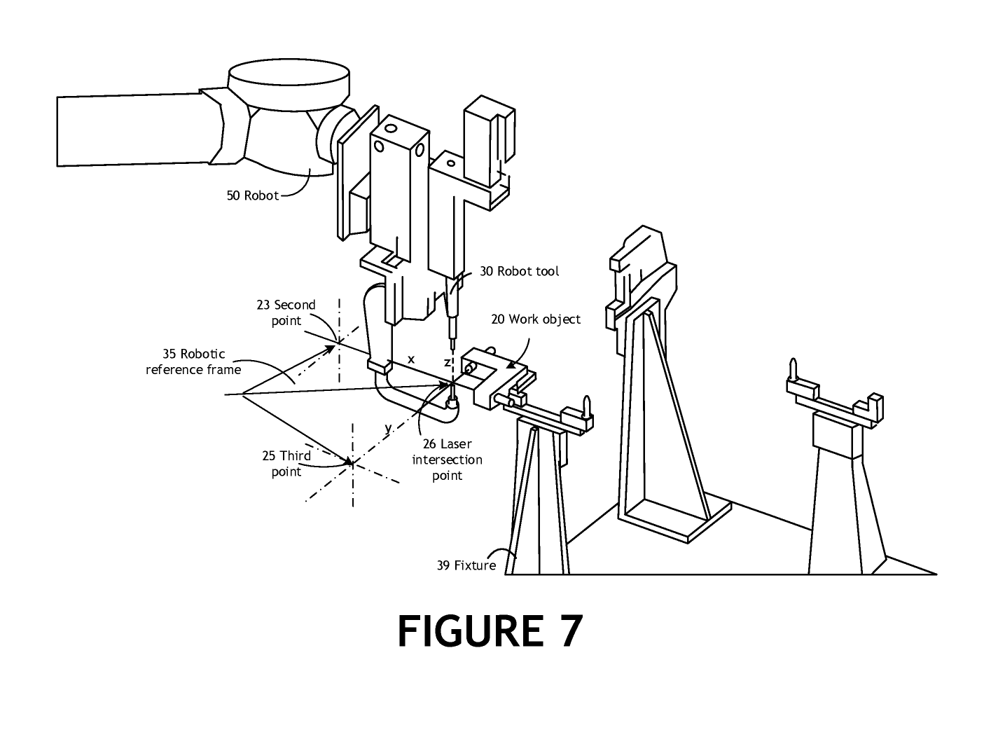

FIG. 7 depicts the robot calibration system of the present invention as installed on a manufacturing shop floor, preferably an automotive shop floor. The technology enables the user to visually see a robotic reference frame [35] (a frame in space that is relative to an industrial robot) that is otherwise abstract and cannot be seen. Enabling the user to visually see the robotic reference frame [35] on the manufacturing shop floor enables the user to adjust the robotic reference frame [35] to the manufacturing shop floor environment and, thereby, correct a robotic path or off-line program to obtain accuracy.

The work object [20] includes two (2) laser beams positioned onto a work piece or tool, at a known location with the two laser beams [22 and 24] intersecting at a 90° angle at a laser intersection point [26] and continuing to project outward.

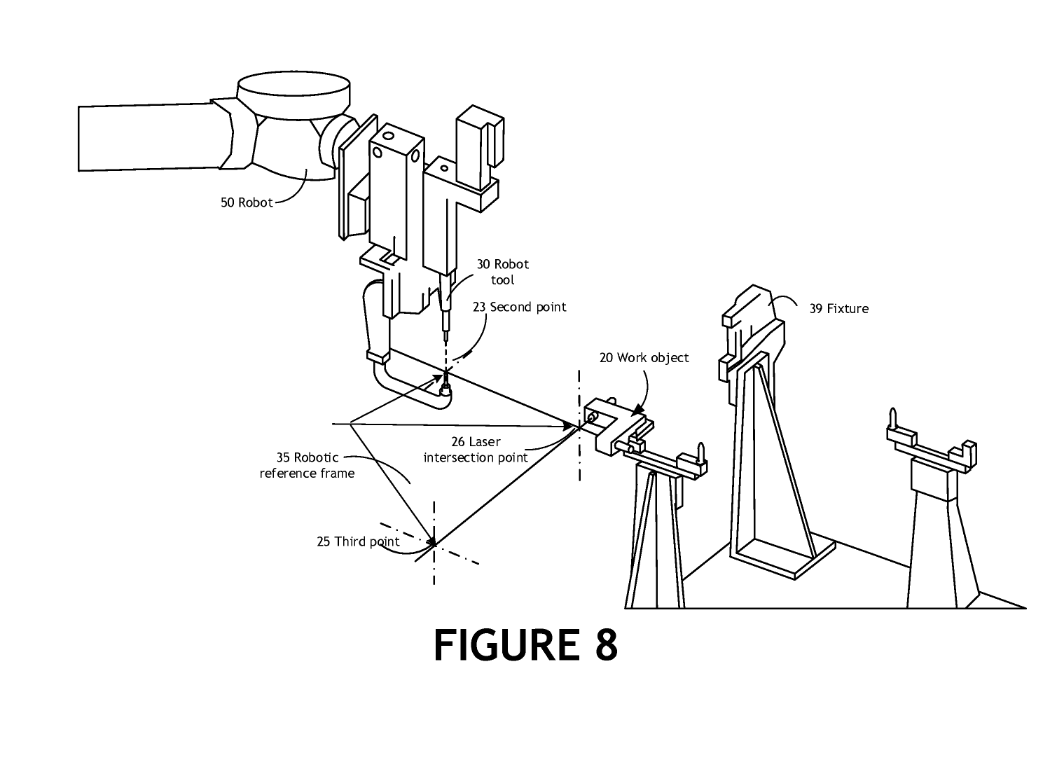

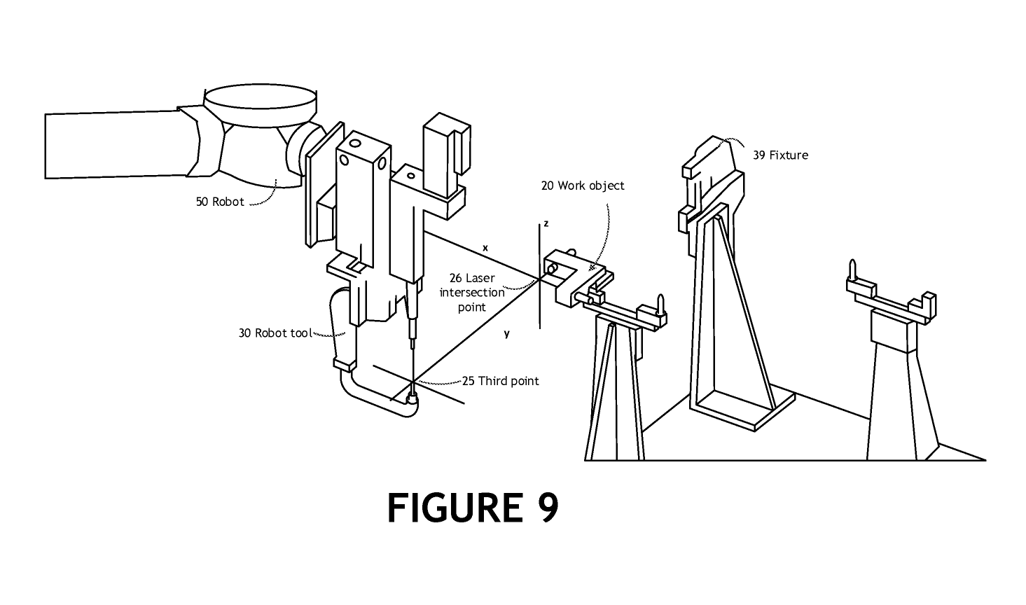

The laser intersection point [26] defines the correct location of the robotic reference frame [35], and is used to calibrate a robot work path on a manufacturing shop floor. To define the robotic reference frame [35], the robot will record a laser intersection point [26] at the intersection of the two (2) laser beams [22 and 24]. A second point [23] is then selected along the axis of the first laser beam [22] at a robot path tag [75] (see FIG. 8). A third point [25] is then selected along the axis of the second laser beam [24] at another robot path tag [75] (see FIG. 9).

In other words, the robotic reference frame [35] is defined by the two intersecting laser beams [22 and 24]. Once all three (3) points [22, 24, and 26] are known, the robotic reference frame [35] is generated. The robotic reference frame is then used to adjust the angular position of the robot tool [30], which enables adjustment of roll, yaw, pitch, roll and yaw; roll and pitch; yaw and pitch; or roll, yaw, and pitch of said robot tool [30]. This method is applicable to all robotic processes including, but not limited to, spot welding, material handling, MIG welding, assembly, cutting, painting and coating, and polishing and finishing.

Using computer-aided design (CAD) simulation software, the user selects a position on the tool that is best suited to avoid crashes with other tooling and for ease of access for the robot or end-of-arm tooling. The off-line programs are then downloaded relative to the work object [20]. The work object [20] preferably mounts onto a fixture [39] using an NC block or standard NAAMS hole pattern mount [47]. The mounts are preferably laser cut to ensure the exact matching of hole sizes for the mounting of parts. The robot technician then manipulates the robot tool [30] into the work object [20] and aligns it with the laser beams [22 and 24] to obtain the difference between the CAD world and manufacturing shop floor. This difference is then entered into the robot [50] and used to define the new robotic reference frame [35]. This calibrates the off-line programs and defines the distance and orientation of the robot tool [30], fixture [39], and peripheral.

The off-line programming with the work object [20] on the fixture [39] enables the work object [20] to be touched up to the “real world position” of the fixture [39] relative to the robot [50]. If the fixture [39] ever needs to be moved or is accidently bumped, the user can simply touch up the work object [20] and the entire path shifts to accommodate the change.

The first and second laser beams [22 and 24] are projected onto known features of the robot tool [30], and then used to calibrate the path of the robot tool [30] and measure the relationship of the fixture [39] relative to the robot tool [30].

The work object [20] has a zero point, a zero reference frame, and a zero theoretical frame in space, which is positioned on the fixture [39].

The work object [20] is placed onto the fixture [39], visually enabling the laser intersection point [26] of the robot tool [30] to be orientated into the work object

obtaining the “real-world” relationship of the robot tool [30] to the fixture [39] while updating the work object [20] to this “real-world” position.

The work object [20] requires that its position correlate with the position of the robot tool [30] to calibrate the path of the robot tool [30] while acquiring the “real-world” distance and orientation of the fixture [39] relative to the robot tool [30]. The work object [20] must have a well-defined location on the manufacturing shop floor, and its position relative to the fixture [39] must be known.

The work object [20] is used to calibrate a “known” calibration device or frame (robotic simulation CAD software provided calibration device). The robotic calibration method of the present invention works by projecting laser beams to a known X, Y, and Z position and defining known geometric planes used to adjust the roll, yaw, and pitch of the robot tool [30] relative to the laser intersection point [26].

The laser beams [22 and 24] are projected onto the end of the robot tool [30] (weld gun, material handler, MIG torch, etc.) where the user will manipulate the robot with end-of-arm tooling into the laser beams [22 and 24] to obtain the positional difference between the “known” off-line program (simulation provided calibration device) and the actual (manufacturing shop floor) calibration device. The reverse is also true. For instance, a material handler robot can carry the work object [20] to a known work piece with known features.

Using CAD simulation software, the CAD user selects a position on the tool to place the robotic work object calibration system that is best suited to avoid crashes with other tooling and for ease of access for the robot [50] or end-of-arm tooling. The off-line programs are then downloaded relative to this work object [20]. The visual work object [20] will be placed onto the tool or work piece in the position that was defined by the CAD user on the manufacturing shop floor. The robot technician then manipulates the robot tool [30] into the work object [20], aligning it to the laser beams [22 and 24] to obtain the difference between the CAD world and manufacturing shop floor. This difference is then entered into the robot and used to define the new calibration device, thus calibrating the off-line programs and defining the distance and orientation of the robot tool [30], fixture [39], peripheral, and other key components.

The work object [20] calibrates the paths to the robot [50] while involving the calibration of the peripherals of the robot [50].

The work object [20] aids in the kitting, or reverse engineering, of robotic systems for future use in conjunction with robotic simulation software. This enables integrators the ability to update their simulation CAD files to the “real world” positions.

The technology uses existing body-in-white procedures, personal computers and software and ways of communicating information amongst the trades.

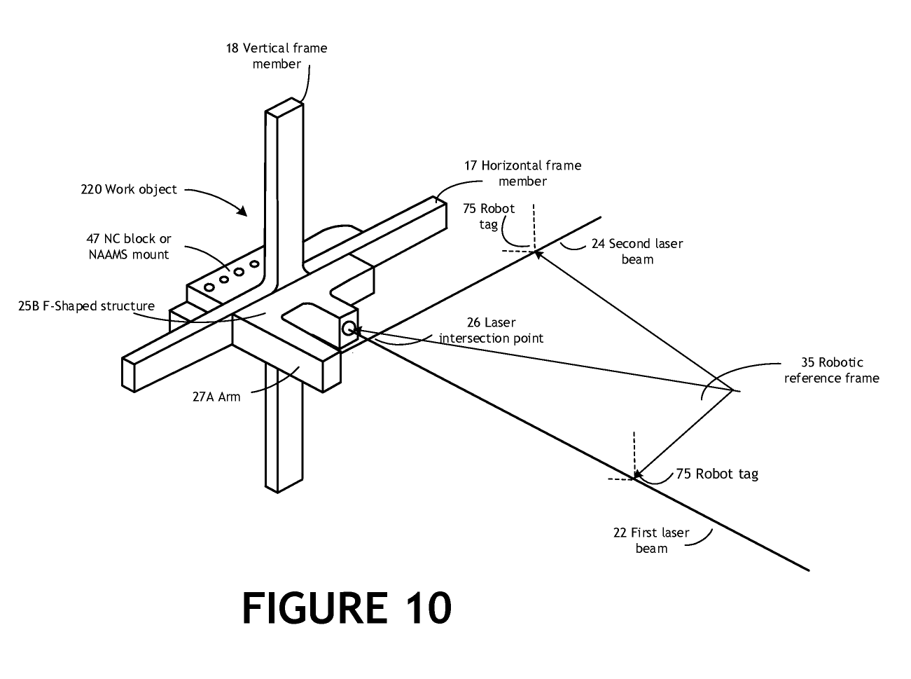

FIG. 10 depicts a perspective view of a third preferred embodiment of the work object [220] for use with the robot calibration system of the present invention, the work object [220] having two laser beams [22 and 24] which define a laser intersection point [26]. In this embodiment, one of the arms of the E-shaped structure of the second preferred embodiment of the work object [120] is truncated, creating an F-shaped structure, enabling the second laser beam [24] to extend beyond the work object [220], unimpeded.

The work object [220] includes a horizontal frame member [17] and a vertical frame member [18]. Extending along the horizontal frame member [17] are two arms parallel which combine to form a squared “F-shaped” structure [25B] which is horizontally aligned and generally centrally disposed relative to horizontal frame member [17] and vertical frame member [18]. A first laser beam [22] is emitted by a laser disposed in the center arm of the F-shaped structure [25B]. A second laser beam [24] is emitted from one of the arms [27A] and is directed unimpeded past the work object [220]. The robotic reference frame [35] is defined by the laser intersection point [26] and the first and second laser beams [22 and 24].The mounting is preferably an NC block or NAAMS mounting pattern [47].

The first laser beam [22] intersects the second laser beam [24] at the laser intersection point [26]. The first and second laser beams [22 and 24] intersect at a 90° angle. The robotic reference frame [35] is defined by the laser intersection point [26] and the first and second laser beams [22 and 24].

The work object [220] is used to calibrate the work path of a robot tool [30] based on a laser intersection point [26] of the robot tool [30] (see FIGS. 7, 8 and 9 for reference). The laser intersection point [26] of the robot tool [30] is defined in three dimensions (X, Y, and Z) and relative to the rotational axes Rₓ (pitch), R_{y} (yaw), and R_{z} (roll) as shown in DETAIL “A”.

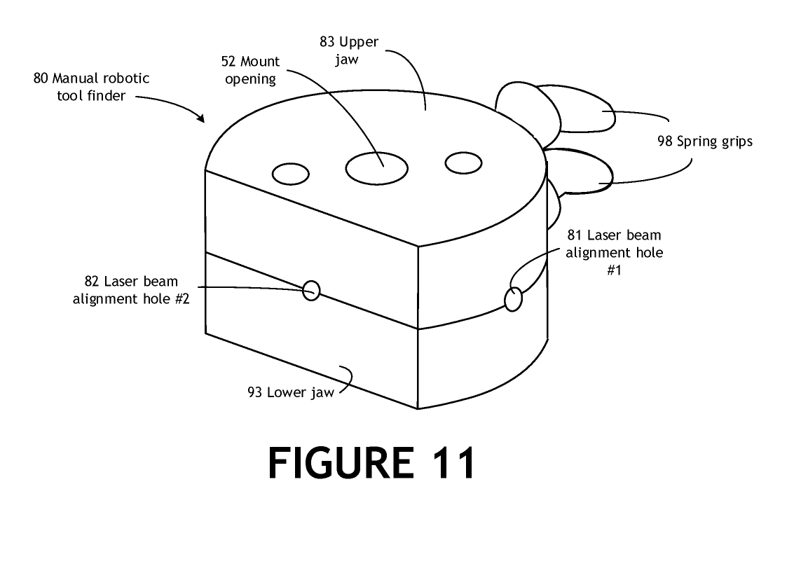

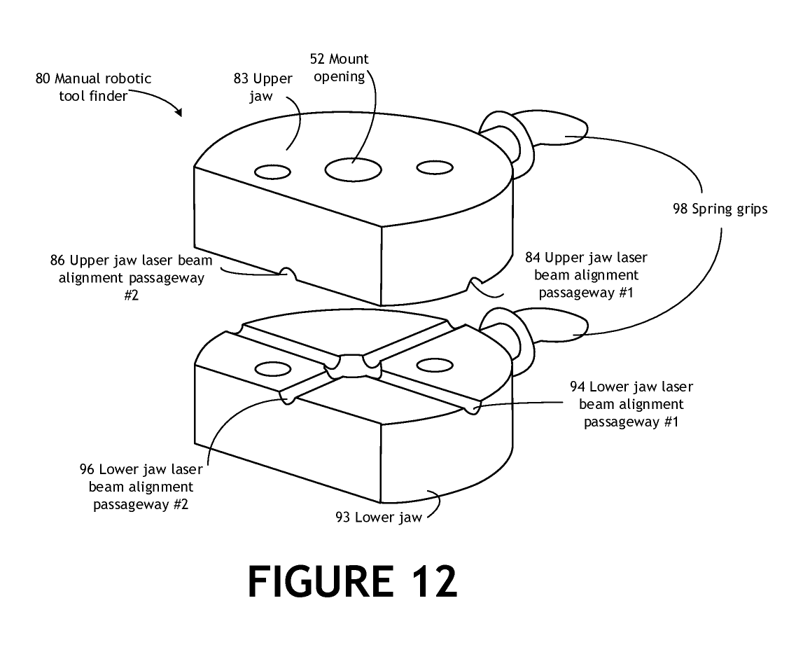

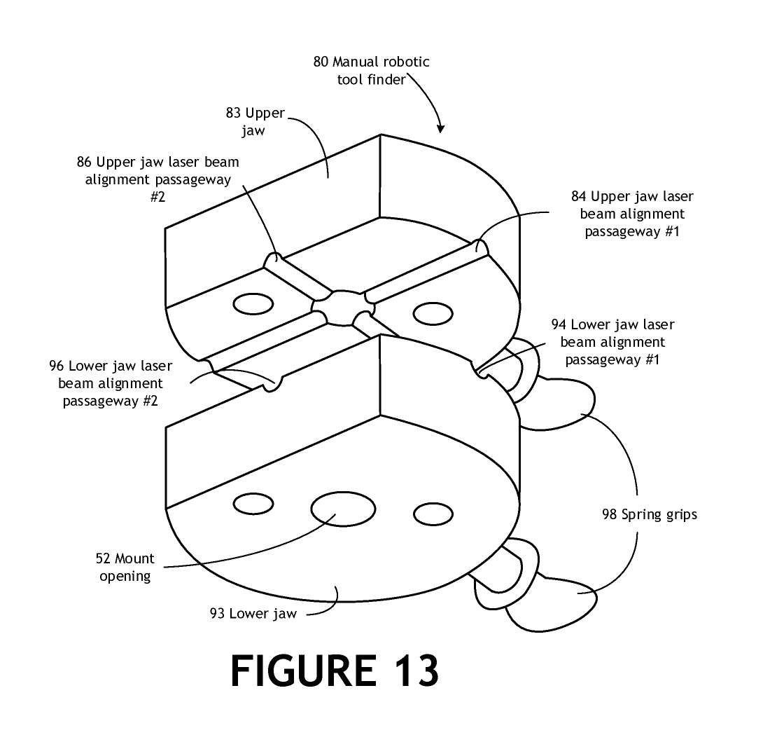

FIGS. 11, 12 and 13 depict a preferred embodiment of a manual robotic tool finder [80] for use in the robot calibration system of the present invention. The manual robotic tool finder [80] has an upper jaw [83] and a lower jaw [93]. A pair of passageways extend through each jaw normal to each other forming a pair of intersecting passageways [84 and 86] through said upper jaw [83] and a pair of passageways [94 and 96] through said lower jaw [93]. A pair of spring grips [98] positioned at the rear of the device enables the device to be opened and closed to gain access to the passageways. The manual robotic tool finder [80] is placed over the laser intersection point [26] of the work object [20, 120, or 220]. The manual robotic tool finder [80] calibrates the robot work path. The manual robotic tool finder [80] includes a mount opening [52] extending therethrough that is used for mounting the device over the weld tips of a weld gun or pin on an end-of-arm-tooling, or other attachment to a robot tool [30].

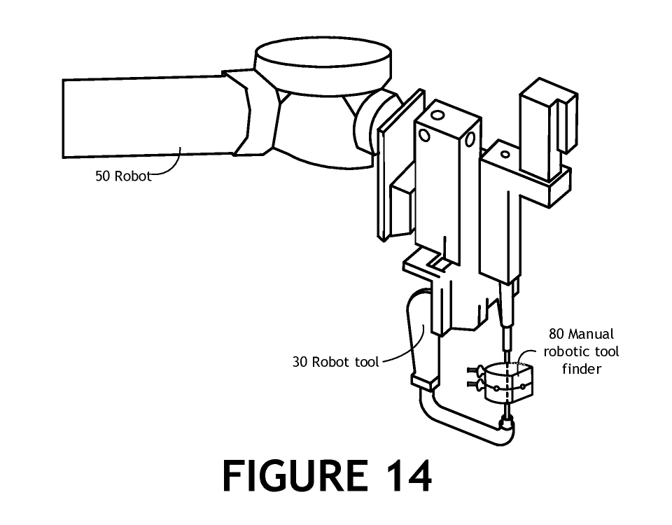

FIG. 14 depicts the manual robotic tool finder [80] mounted in a robot tool [30].

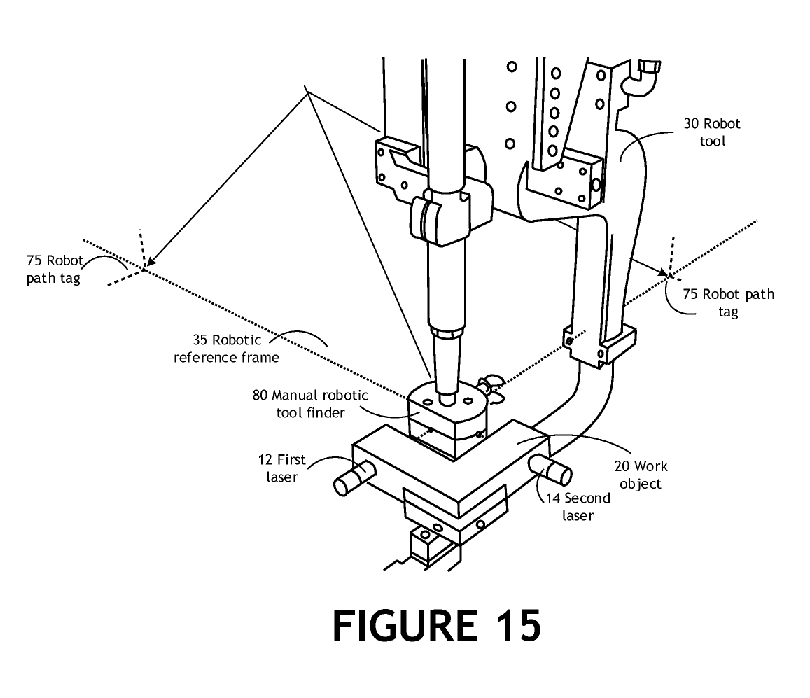

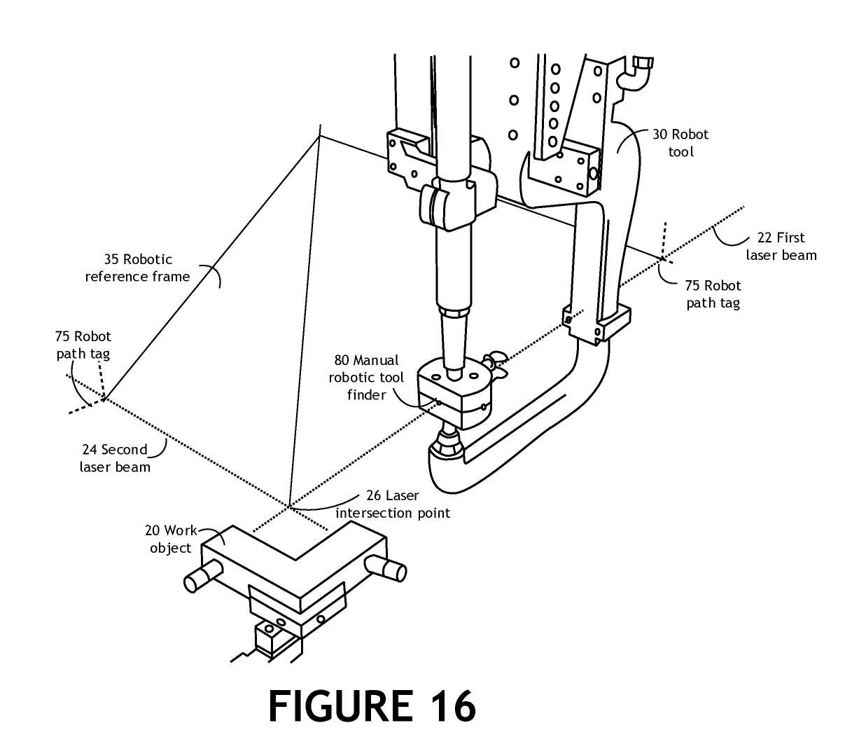

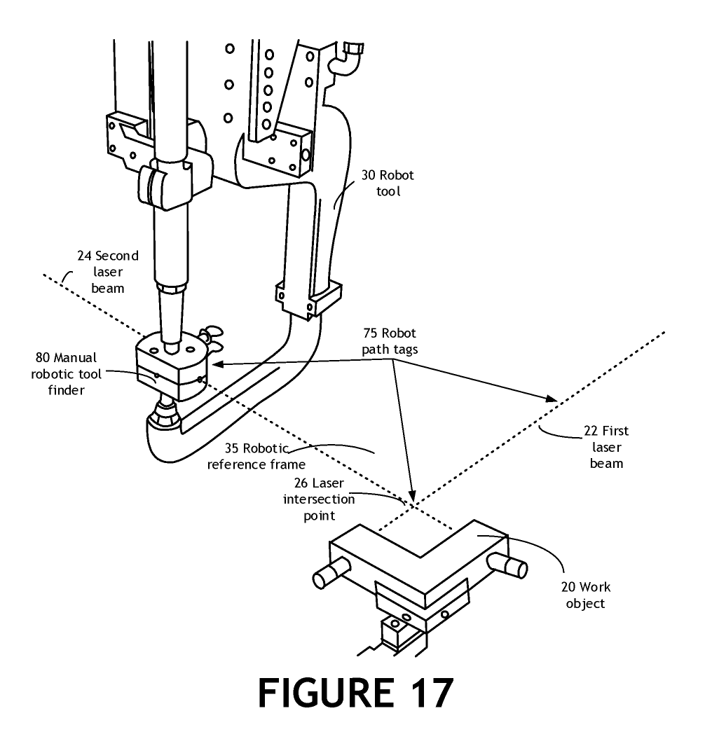

FIGS. 15, 16, and 17 depict a second preferred embodiment of the robot calibration system [10] of the present invention. The manual robotic tool finder [80] is mounted on a robot tool [30] being used with the work object [20] mounted on fixture [39]. The manual robotic tool finder [80] cooperatively engages with the work object [20], which defines a robotic reference frame [35] (a frame in space that is relative to an industrial robot [50] and work piece tool) that is otherwise abstract and cannot be seen. The work object [20] includes two lasers [12 and 14] mounted onto a work piece or tool, at a known location with the two laser beams [22 and 24] intersecting at a 90° angle and continuing to project outward. The mounting is preferably an NC block or a NAAMS mounting pattern [47]. The laser intersection point [26] of the robot defines the correct location of the robotic reference frame [35]. To accomplish this, the robot will record a laser intersection point [26] (see FIG. 15). A second point [23] is then selected along the axis of the first laser beam [22] at a robot path tag [75] (see FIG. 16). A third point [25] is then selected along the axis of the second laser beam [24] at another robot path tag [75] (see FIG. 17).

The robot calibration systems of the present invention as described herein are compatible with robotic simulation packages, including but not limited to, Robcad® which is a registered trademark of Tecnomatix Technologies Ltd., Delmia® which is a registered trademark of Dassault Systèmes, Roboguide® which is a registered trademark of Fanuc Ltd. Corp., and RobotStudio® which is a registered trademark of ABB Corp.

Throughout this application, various Patents and Applications are referenced by number and inventor. The disclosures of these Patents/Applications in their entireties are hereby incorporated by reference into this specification in order to more fully describe the state of the art to which this invention pertains.

It is evident that many alternatives, modifications, and variations of the robot calibration systems of the present invention will be apparent to those skilled in the art in light of the disclosure herein. It is intended that the metes and bounds of the present invention be determined by the appended claims rather than by the language of the above specification, and that all such alternatives, modifications, and variations which form a conjointly cooperative equivalent are intended to be included within the spirit and scope of these claims.

### Parts List

10. Robot calibration system
12. First laser
14. Second laser
17. Horizontal frame member
18. Vertical frame member
20. Work object (1st embodiment)
22. First laser beam
23. Second point
24. Second laser beam
25. Third point
25A. E-shaped structure with opening
25B. F-shaped structure
26. Laser intersection point
27A. E-shaped member end arm w/laser
27B. E-shaped member end arm w/opening
27C. E-shaped member center arm
29. Opening
30. Robot tool
35. Robotic reference frame
39. Fixture
46. Wedge
47. NC block or NAAMS mount
50. Robot
52. Mount opening
75. Robot path tag
80. Manual robotic tool finder
81. Laser beam alignment hole #1
82. Laser beam alignment hole #2
83. Upper jaw
84. Upper jaw laser beam alignment passageway #1
86. Upper jaw laser beam alignment passageway #2
93. Lower jaw
94. Lower jaw laser beam alignment passageway #1
96. Lower jaw laser beam alignment passageway #2
98. Spring grips
120. Work object (2^{nd} embodiment)
220. Work object (3^{rd} embodiment)

I claim:

1. A method for calibrating a robot work path on a manufacturing shop floor using CAD means by deployment of a calibration system, said calibration system including a work object, said work object including a first and a second laser, said first laser projecting a first laser beam, said second laser projecting a second laser beam, said first laser beam intersecting said second laser beam at a laser intersection point, the method comprising:
a. securely mounting said work object to a fixture relative to a robot tool, said fixture being positioned on said manufacturing shop floor;
b. generating a robotic reference frame, said robotic reference frame including said first and said second laser beams;
c. manipulating said robot tool into alignment with said laser intersection point on said manufacturing shop floor, so as to enable calibration of said robot work path for said robot tool relative to said laser intersection point when said work object is mounted onto said fixture; and
d. using said robotic reference frame to calibrate said robot work path of said robot tool using CAD simulation software.

2. The method of claim 1, wherein said first and second laser beams intersect at a 90 degree angle.

3. The method of claim 1, wherein said work object is mounted onto a fixture using a numerical control block or a NAAMS hole pattern mount.

4. The method of claim 1, wherein said robotic reference frame is defined by said laser intersection point, a second point disposed along said first laser beam other than at said laser intersection point, and a third point disposed along said second laser beam other than said laser intersection point.

5. The method of claim 1, wherein said robotic reference frame is defined by said first laser beam, and said second laser beam.

6. The method of claim 1, wherein said work object is mounted onto a fixture using a numerical control block or NAAMS hole pattern mount.

7. The method of claim 1, further comprising downloading an offline program relative to said work object, said work object being disposed relative to said robot tool in a position on said manufacturing shop floor defined by CAD simulation software.

8. A work object for calibrating a robot work path on a manufacturing shop floor relative to a robot tool, said work object comprising:
a. a first laser mounted on said work object, said first laser projecting a first laser beam relative to said robot tool;
b. a second laser mounted on said work object, said second laser projecting a second laser beam relative to said robot tool, said second laser beam intersecting said first laser beam at a laser intersection point;
c. a robotic reference frame including said first and second laser, calibration of said robot work path deploying said robotic reference frame using CAD simulation software;
whereby angular positions (Rₓ, R_{y}, and R_{z}) of said robot tool are adjustable on said manufacturing shop floor relative to said robotic reference frame.

9. The work object of claim 8, wherein said first and second laser beams intersect at a 90 degree angle.

10. The work object of claim 8, wherein said robotic reference frame is defined by said laser intersection point, a second point disposed along said first laser beam other than at said laser intersection point, and a third point disposed along said second laser beam other than said laser intersection point.

11. The work object of claim 8, wherein said robotic reference frame is defined by a first point disposed at said laser intersection point, said first laser beam, and said second laser beam.

12. The work object of claim 8, wherein said work object is mounted onto a fixture on a manufacturing shop floor using a numerical control block or a NAAMS hole pattern mount.

13. A system for calibrating a robot work path on a manufacturing shop floor using CAD means, the system comprising:
a. a robot having a robot tool disposed thereon; and
b. a work object being mountable onto a fixed mounting position relative to said robot tool, said work object having a first and a second laser, said first laser emitting a first laser beam, said second laser emitting a second laser beam, said first laser beam intersecting said second laser beam at a laser intersection point, said laser intersection point defining a location of a robotic reference frame;
whereby angular positions (Rₓ, R_{y}, and R_{z}) of said robot tool are adjustable on said manufacturing shop floor relative to said robotic reference frame.

14. The system of claim 13, wherein said first and said second laser beams intersect at a 90 degree angle.

15. The system of claim 13, wherein said robotic reference frame is defined by a first point disposed at said laser intersection point, a second point disposed along said first laser beam other than at said laser intersection point, and a third point disposed along said second laser beam other than said laser intersection point.

16. The system of claim 13, wherein said robotic reference frame is defined by said laser intersection point, said first laser beam, and said second laser beam.

17. The system of claim 13, wherein said work object is mountable on a fixture positioned on said manufacturing shop floor.

18. The system of claim 13, wherein said manufacturing shop floor is an automotive shop floor.

19. The system of claim 17, wherein said work object is mounted onto said fixture using a numerical control block or a NAAMS hole pattern mount.

20. The system of claim 13, wherein said work object includes a downloaded offline program relative to said work object, said work object being disposed relative to said robot tool in a position on said manufacturing shop floor as defined by CAD simulation software.
